(19) United States
(12) Patent Application Publication
(10) Pub. No.: US 2005/0218169 A1
(43) Pub. Date: Oct. 6, 2005

(54) Storage case for use in vehicles

(76) Inventor: Wai Ming Lau, Kowloon (HK)

Correspondence Address: Friedrich Kueffner, Suite 910, 317 Madison Avenue, New York, NY, 10017, US

(21) Appl. No.: 11/088,681

(22) Filed: Mar. 24, 2005

(30) Foreign Application Priority Data
Mar. 26, 2004 (DE) 10 2004 015 476.7

(51) Int. Cl. B60R 7/05

(52) U.S. Cl. 224/312

(57) ABSTRACT

A storage case for use in vehicles with includes least one insert for holding disk-shaped data storage media, especially CDs and/or DVDs. A cover of the storage case can be flipped up or slid aside to allow access to at least one disk-shaped data storage medium. A plurality of inserts may be arranged at least partially on top of each other. Fastening structures may be provided for separating the inserts from each other and for holding the inserts together.

### BACKGROUND OF THE INVENTION

1. Field of the Invention

The present invention relates to a storage case for use in vehicles with at least one insert for the storage of disk-shaped data storage media.

2. Description of the Related Art

It is known that disk-shaped data storage media, especially CDs, DVDs, VCDs, and similar data-formatted storage media can be stored in a protected environment when they are used at home.

### SUMMARY OF THE INVENTION

It is the object of the present invention to create the possibility of guaranteeing the safe storage of data storage media in mobile environments as well.

According to the invention, a storage case is provided for use in vehicles with at least one insert for the storage of disk-shaped data storage media, especially CDs and/or DVDs, wherein a cover of the storage case can be flipped open or slid aside in order to offer access to at least one disk-shaped data storage medium.

In particular, the storage case has surfaces of rigid, especially of unbreakable, material. Rigid plastics material can be used, for example, for this purpose. It is also possible for the storage case to have a rigid core structure, in which at least one data storage medium is securely held. A more resilient material is provided around the rigid structure. In particular, cushioning material can be provided around the structure.

According to one embodiment, the storage case for use in vehicles has a plurality of inserts, which lie on top of each other at least to some extent. This makes it possible for the storage media to be accommodated in a minimum of space. The storage case can thus be made quite thin and can be located on any of various interior parts of the vehicle.

The insert for holding the disk-shaped storage media can consist of a flexible or of a rigid material. The insert can also have a part with a rigid geometry and a part with a flexible geometry. For example, the insert can have a retaining element, which can hold the storage medium in a fixed position or define that position. For this purpose, the insert can have at least one gripping element, which makes it possible to establish a positive and/or nonpositive connection with the storage medium. According to another embodiment, the insert is flexible and rests on the top and bottom surfaces of the storage medium to hold it in place. According to yet another embodiment, the insert has a receptacle which conforms to the contour of the storage medium. The storage medium can be centered in this receptacle. The storage medium can be either held firmly in place or allowed a certain freedom of movement. The latter approach is especially advantageous when the storage case has other functions in addition to its primary secure storage function. For example, a system for accessing the information on the storage medium can be mounted in or on the storage case. As a result, one or more storage media can be not only stored securely in the vehicle but also played back in this safe environment. It is also possible for the storage case to integrate additional functions. These can comprise display functions, input functions, or miscellaneous playback options.

According to a further development, the storage case has several inserts which are separate from each other. The inserts are held together by at least one lateral and/or centrally located fastening structure. As a result, the fastening structures can serve simultaneously to exert a pulling force on the inserts when the storage case is opened. The pull is thus transmitted from one insert to the next, which leads in particular to the creation of gaps between the inserts.

It has been found advantageous for the storage case to have at least one connector element by which it can be fastened detachably to an interior component of the vehicle. This makes it possible for the storage case to be fastened to the interior of the vehicle and thus prevented from shifting location. The case can also be removed from the interior of the vehicle again, the fastening method being designed in particular so that the interior component to which the storage case has been attached is not affected or at least is not destroyed by such removal. In particular, the connector element is designed so that the storage case can be attached to and detached from the interior component repeatedly. The connector element, in cooperation with the interior component, provides a secure but also detachable connection, so that the case can be removed simply by overcoming a release force or a release mechanism. Therefore, the storage case cannot move around in the interior of the vehicle unpredictably. This prevents accidents from happening to the passengers in the vehicle.

According to another embodiment, at least two disk-shaped storage media can be arranged next to each other in the storage case. For this purpose, a common insert can be provided, as a result of which the number of parts required to made the case can be reduced.

According to another development, the storage case is integrated into a shield. The shield as such is preferably installed so that it can be moved from place to place inside the vehicle. The shield can be used to cover an empty space, for example. The shield can also be used as a rigid cover.

According to an embodiment, the storage case is integrated into a visor. The design of the visor will be adapted here to that of the storage case. The case can be integrated completely and permanently into the visor. According to another embodiment, the storage case is integrated into the visor in such a way that it can be attached to and detached from it repeatedly. Because the visor itself can be moved about freely in the vehicle, especially in the area of the inside roof lining, the visor and thus the storage case can be moved into a position in which the data storage medium or media can be readily accessed. In other positions of the visor, access to the storage media is not possible. In this way, the ability to change the position of the visor assumes an additional function, namely that of protection, for the storage media. The visor is installed in particular in such a way that the heat which can be caused by solar radiation is prevented from directly reaching the storage media in the storage case. For this purpose, the storage media can be located, for example, on one side of the visor, namely, on the side which does not face the sun when the visor is in use. If the visor can be pivoted by an angle of 90° around a suspension point and thus positioned to prevent the sun's rays from entering either the front windshield or the side window, the storage media will preferably be installed in the visor opposite the front windshield. A layer of thermal insulation can also be provided in the visor to protect the storage media.

According to another embodiment, the insert is recessed into the visor. Thus a very thin visor can be obtained. By stacking the inserts and especially by stacking them with a certain lateral offset, the thickness of the storage case and also the amount of space required for it around the sides can be adapted to the space required for the visor. According to an elaboration, a storage case for vehicles integrated into a visor has one or more inserts, each of which has an opening which faces the side. The inserts are arranged so that the storage medium can be introduced or removed in the sideways direction when the visor is in its functional position. According to one embodiment, the storage media can be removed in the sideways direction, for example, when the visor is in its flipped-up position. According to another embodiment, the storage media can be removed from the storage case in the direction toward the user when the visor is in its flipped-up position. A visor into which a storage case has been integrated can be installed on the passenger's side or on the driver's side. It is also possible for the insert to be mounted on one side of the visor and for another functional component to be installed on the other side of the visor. In particular, this other functional component can be a mirror. The functional component can also be, for example, a display unit, an input unit, etc. According to another embodiment, the insert and the functional component, especially a mirror, are located on the same side of the visor. The connector element, furthermore, can be used as part of a system for supplying electrical power to a lamp or the like.

The storage case for use in vehicles is preferably designed so that a plurality of storage media can be kept securely in it. In particular, between three and eight disk-shaped storage media, preferably between five and seven, and even more preferably six disk-shaped storage media in all can be stored in the storage case.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of a first storage case for use in vehicles;

FIG. 2 is a side view of the storage case according to FIG. 1 in the opened state;

FIG. 3 is a front view of the storage case according to FIG. 2;

FIG. 4 is a second storage case for use in vehicles in the form of a visor;

FIG. 5 is the second storage case with an opened cover;

FIG. 6 is a bottom view of the second storage case, into which a functional element has been integrated;

FIG. 7 is a side view of the visor into which a storage case of the second type has been integrated, where both its cover and the functional element are in the flipped-open position;

FIG. 8 is a side view of the visor with both the cover and the functional element in the closed position;

FIG. 9 is an arrangement of two storage cases as visors in a vehicle; and

FIG. 10 is an arrangement of a storage case on the center console of a vehicle.

### DETAILED DESCRIPTION OF THE INVENTION

FIG. 1 shows a top view of a closed storage case 1 for use in vehicles. The storage case 1 has a first shell 2 and a second shell 3. The first shell 2 and the second shell 3 can preferably be separated from each other around the entire length of their coinciding edges. This makes it possible to install fastening structures inside between the first shell 2 and the second shell 3. These structures connect the shells 2, 3 to each other and also connect the inserts held between the shells 2, 3 to each other. The second shell 3 has an actuating area 4, which makes it possible to create an opening between the first shell 2 and the second shell 3. This is preferably done by exerting pressure on the actuating area 4. An appropriate locking mechanism can be provided between the first shell 2 and the second shell 3. The locking mechanism can, for example, be designed to act either positively or nonpositively. For example, it is possible for the actuating area 4 to consist of one type of material and for another part, which interacts with the actuating area 4, to consist of another type of material. If plastics are used, for example, one part can be more flexible, preferably softer, than the other, which thus makes it possible for the shells 2, 3 to be opened and closed. A latching mechanism can also be used. The joint area 5, where the edges of the shells 2, 3 meet, preferably proceeds directly around the circumference of the storage case 1. In particular the joint area 5 is designed to make a precise fit, so that it simultaneously can function as a seal. A separate seal element can also be provided, however. This makes it possible to protect the contents from spray water and moisture. The storage case 1 also has a connector 6. The connector 6 is used to fasten the storage case 1 to an interior component of the vehicle. For example, the connector 6 can be fastened to the interior component by means of a plug-and-socket system, as indicated schematically. The plug-and-socket system has, for example, a pin-type connecting element, which centers and positions the case. The connector 6 preferably makes it possible for the storage case 1 to be detached via the connector 6 from the interior component merely by exerting enough force to overcome a certain resistance. A lock can also be provided for safety. It is also possible for the connector 6 to be inserted into an appropriate geometry of the interior component, whereupon, by means of a turning, pivoting, or similar movement, the storage case 1 can be latched or locked in a predetermined position.

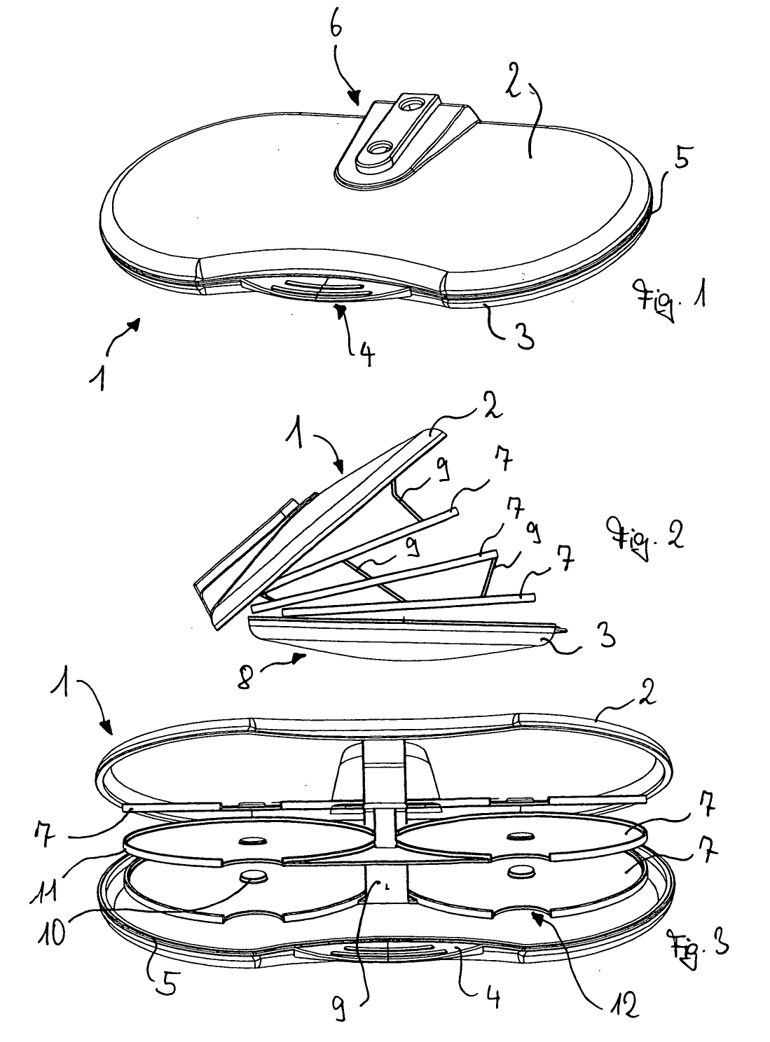

FIG. 2 shows the opened storage case 1 of FIG. 1. Between the shells 2, 3 are three inserts 7. The inserts 7 can serve directly or indirectly as linking elements between the shells 2, 3. When the storage case 1 is flipped open by moving the second shell 3 away from the first shell 2, the second shell 3 acts as a cover which can be opened to offer access to the inserts 7. The inserts 7 can be pulled away from each other by the fastening structures 9. The fastening structures 9 can be of different lengths to prescribe a certain movements when the storage case 1 is opened. As illustrated, the shells 2, 3 are in the opened state, but they are not connected directly to each other; that is, there is no joint immediately between them. This allows the two shells 2, 3 to move with considerable freedom with respect to each other, which makes it very easy to access the inserts 7.

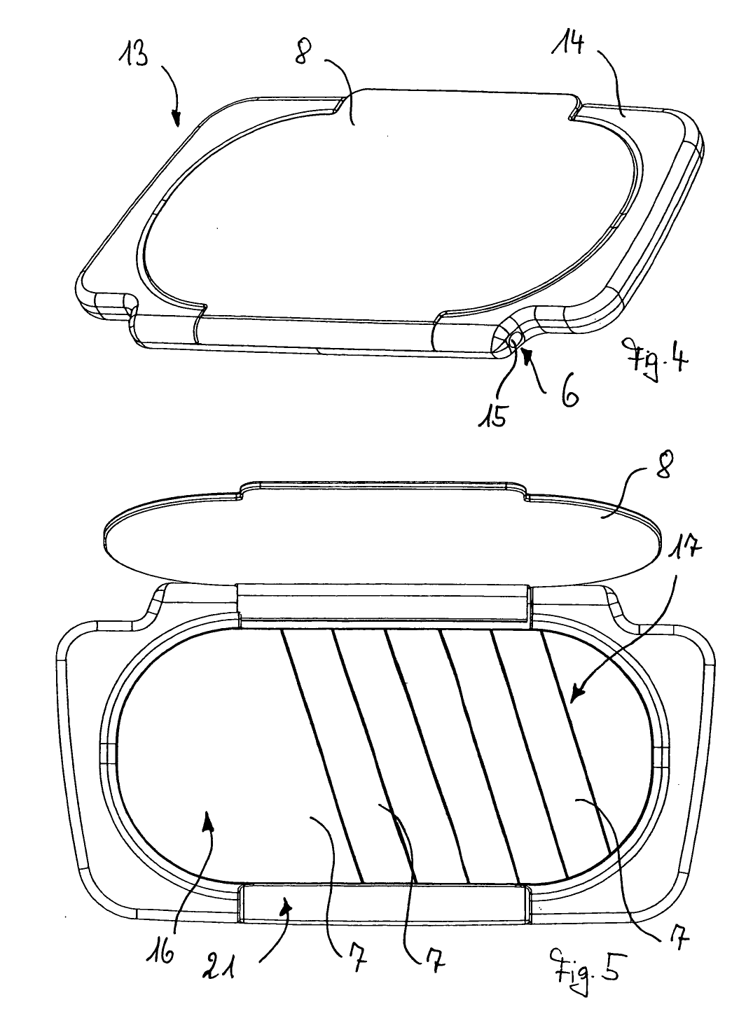

FIG. 3 shows the storage case 1 in the opened position. The inserts 7 make it possible for two storage media to be accommodated next to each other. To obtain an especially space-saving design of the storage case 1, the external contour of the inserts 7 conforms to that of the storage media. This contour is copied by the external shape of the storage case 1. As a result, an especially space-saving design is achieved, where the area between the storage media can be used for the actuating area 4 and also for the fastening structures 9. The fastening structures 9 can be made of flexible plastic or other material, which preferably folds up when the storage case is closed again. The inserts 7 have not only centering elements 10 but also protective rims 11, which prevent damage to the edges of the storage media by impacts after the media have been inserted. In addition, the insert 7 for each storage medium has a cutout 21, which makes it easier to grip the storage medium and also easier to insert the storage medium again. According to an elaboration, the fastening structures 9 can also be elastic. This makes it possible to move the insert 7 even farther away from the first shell 2, for example, simply by exerting force on the insert. The joint area 5 between the shells 2, 3 has steps so that a sealing effect is obtained. It is also possible, however, to provide flat surfaces, which simply rest on each other. A sealing effect can then be achieved, for example, by the pressure which the two flat surfaces exert on each other.

FIG. 4 shows a storage case 13 of a second type for use in vehicles. The second storage case 13 is designed as a visor 14. For this purpose, a cover 8 is fitted into the visor 14. In particular, the surface of the visor 14 is flat at least over most of the visor. The cover 8 is hinged to the visor 14. In particular, the hinged arrangement is axially parallel to the connector 6. For example, the connector 6 can make it possible for the visor to be inserted into an interior component of the vehicle. For this purpose, the connector 6 can have sockets 15 for pins or can itself carry the pins. As a result, the visor can be pivoted, and when it is pivoted, the second storage case 13 pivots at the same time. According to another embodiment, suitable hinged connections to the interior component can make it possible for the visor to be pivoted in any desired direction.

FIG. 5 shows the cover 8, which is hinged to the visor 14, in the flipped-open position. The inserts 7 are present in a cavity 16 in the visor 14. These have side openings 17, which means that the inserted storage media cannot fall out of the visor 14 when the cover 8 is opened. The visor 14 also has a case-opening area 21. This area provide a gripping element, for example, which makes it possible to open the cover 8.

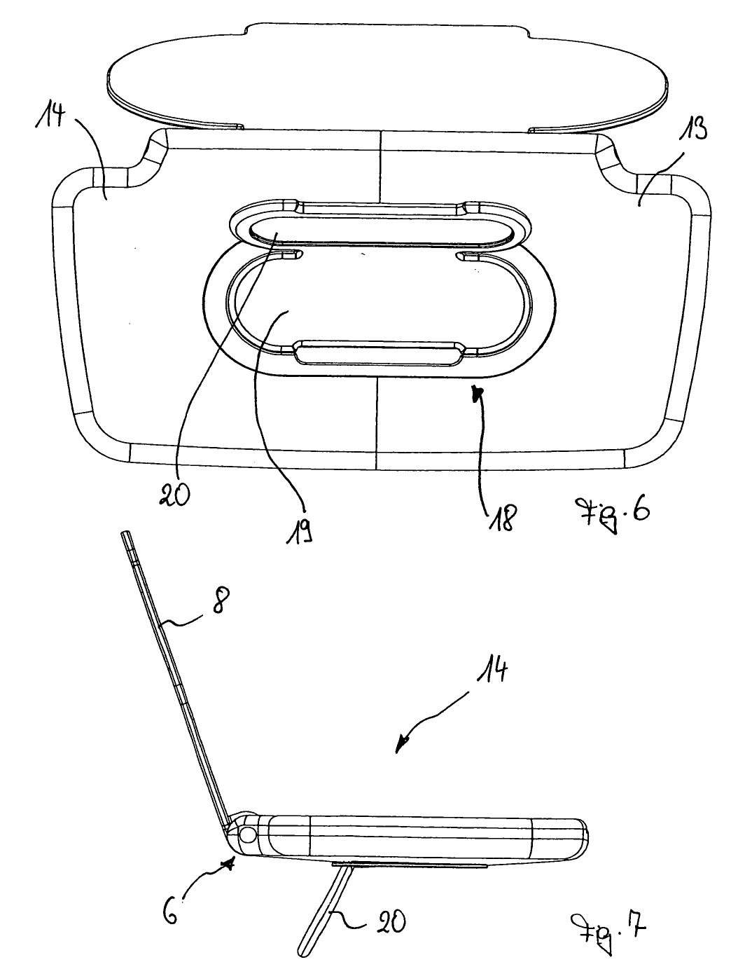

FIG. 6 shows a rear view of the second storage case 13 in the form of a visor 14. A functional component 18 is integrated into this rear surface. The functional component is in particular a mirror 19. The functional component 18, especially the mirror 19, can be covered by a protective element 20. The protective element 20 is preferably able to pivot and even more preferably able to flip upward. It can also be designed to slide sideways in the visor 14. In particular, the functional component 18 can be mounted on the surface of the visor 14. As a result, a larger space for storing the storage media becomes available in the interior of the visor 14. According to another embodiment, however, it is also possible for the functional component 18 to be recessed at least into the visor 14.

FIG. 7 shows the visor with the cover 8 and the protective element 20 in their flipped-open positions. The cover 8 and the protective element 20 are preferably arranged so that they can be moved with respect to the other parts of the visor 14 by overcoming a certain retaining resistance. It is also possible that at least the cover 8 can be brought into a latching position after it has been flipped open. The cover 8 is thus prevented from closing unintentionally. Although it is possible to hinge the cover 8 to the visor 14 on the side where the connector 6 is located, it is also possible to hinge the cover 8 to the other side. This can be either one of the transverse sides or the side of the visor 14 opposite the connector 6. The same is also true for the hinging of the protective element 20.

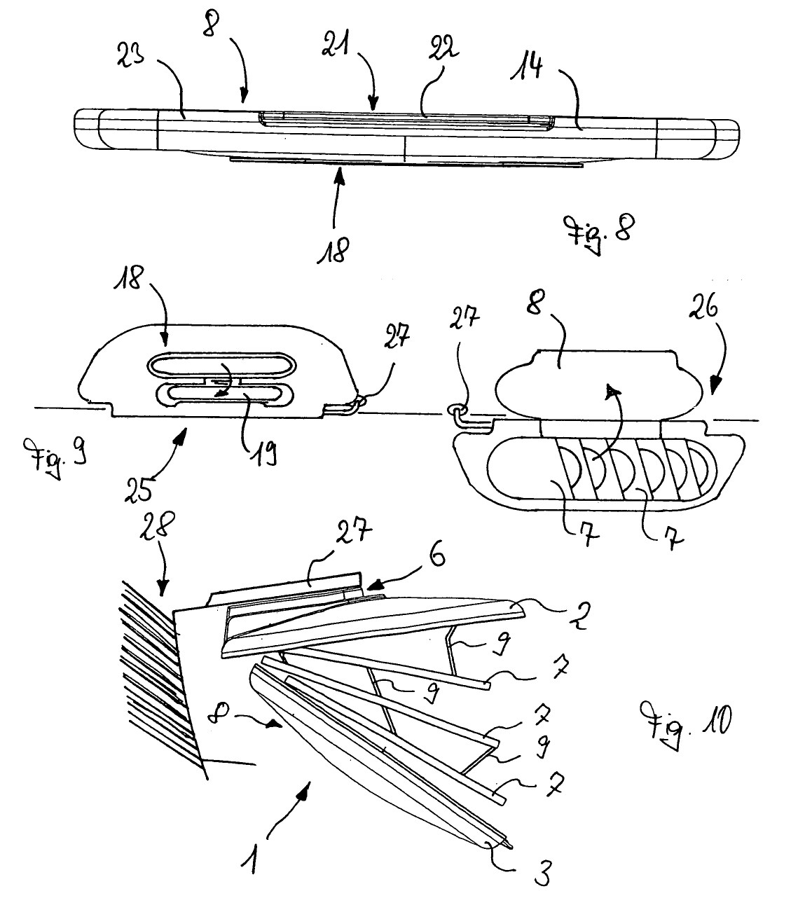

FIG. 8 shows a side view of the visor 14, in which both the cover 8 and the functional component 18 are in their closed positions. The case-opening area 21 has, for example, an edge 22, which projects beyond the boundary 23 of the visor 14. As a result, the cover 8 can be gripped and opened more easily. According to an elaboration, the inserts 7, which are arranged in the interior of the visor when the cover 8 is closed, are moved concomitantly with the cover 8 when the cover 8 is opened. The inserts are thus attached to the cover 8 itself. It is also possible for the inserts to unfold like an accordion when the cover 8 is lifted.

FIG. 9 shows an arrangement of two visors, i.e., a first visor 24 and a second visor 25. The visor 25, 26 are fastened to an interior component 27 in the upper area of a vehicle by means of their connectors. The first visor 25 is flipped upward, so that it is facing the inside lining of the roof. The functional component 18 can now be flipped open, as indicated by the arrow. Because the mirror 19 is located on the part which can be flipped open, it can be pivoted into any position. It would be possible not only to pivot the mirror 19 but also to rotate by means of, for example, an appropriate hinged connection to the first visor 25. The second visor 26 is in a flipped-down position, where it can provide protection from the sun's rays by covering a certain part of a window. The cover 8 is flipped up, as indicated by the arrow. CDs are stored inside the second visor 26 and can be removed preferably in a sideways direction. The CDs are held in, for example, a nonwoven material or in some other soft material, and because of the softness of this material they can be pushed easily into the corresponding inserts 7. It is also possible for the side of the cover 8 facing the CDs to have a function such as that of holding a mirror. The second visor 26 can accommodate preferably six CDs.

FIG. 10 shows the storage case 1, which is attached by its connector 6 to the interior component 27 of the vehicle. The interior component 27 is preferably a central console. The interior component can have a mounting rail, into which the connector 7 can be inserted and fastened. The interior component can also have a socket-like component for the insertion of the connector. The CDs held in the storage case 1 can preferably be removed from the front or from the side. Because the storage case 1 is mounted on the central console 28, both the driver and the passenger can use it. The case is mounted on the console preferably in such a way that a free space is present underneath the console, into which the storage case can be opened, i.e., so that it can be opened in the downward direction.

The storage case preferably has only a single connector 6. This is preferably arranged centrally on top, as illustrated by way of example in FIG. 10. The connector can also be provided on the side, however, as can be derived from FIG. 9. If two connectors are provided, they are preferably located on only one side of the storage case. This makes it possible for the storage case to be mounted in the vehicle with freedom of movement around a fixed point in the vehicle. It is possible to use not only plastics such as polypropylene, etc., especially high-impact plastics, but also other materials such as polyethylene, nonwovens, foam materials, metals (especially to reinforce the edges and to serve as frames), and/or other materials.

1. A storage case for use in vehicles, the storage case comprising at least one insert for holding disk-shaped data storage media, especially CDs and/or DVDs, and a cover of the storage case configured to be flipped open or slid aside to allow access to at least one disk-shaped data storage medium.

2. A storage case for use in vehicles according to claim 1, wherein the storage case comprises a plurality of inserts which are stacked at least partially on top of each other.

3. A storage case for use in vehicles according to claim 2, comprising fastening structures located at least on one side and/or in the center for separating the inserts from each other and holding the inserts together.

4. The storage case for use in vehicles according to claims 1, comprising at least one connector for detachably connecting the storage case to an interior component of the vehicle.

5. The storage case for use in vehicles according to claim 1, wherein the storage case is configured such that at least two disk-shaped data storage media can be arranged next to each other.

6. The storage case for use in vehicles according to claim 1, wherein the storage case is integrated into a shield.

7. The storage case for use in vehicles according to claim 1, wherein the storage case is integrated into a visor.

8. The storage case for use in vehicles according to claim 7, wherein the insert is recessed into the visor.

9. The storage case for use in vehicles according to claim 7, wherein the insert has a lateral opening and is arranged in such a way that, in an installed state of the visor, the storage medium can be inserted or removed from the side.

10. The storage case for use in vehicles according to claim 7, wherein the insert is arranged on one side of the visor, and a functional component is mounted on the other side.

11. The storage case for use in vehicles according to claim 10, wherein the functional element is a mirror.

12. The storage case for use in vehicles according to claim 7, wherein the inserts and a functional component are arranged on one side of the visor.

13. The storage case for use in vehicles according to claim 12, wherein the functional element is a mirror.
